(19) United States
(12) Patent Application Publication
(10) Pub. No.: US 2014/0113056 A1
(43) Pub. Date: Apr. 24, 2014

(54) SPREAD

(71) Applicants: Paul Wassell, East Sussex (GB); Mark Farmer, Oron la Ville (CH); Stuart Andrew Warner, Copenhagen K (DK); Allan Torben Bech, Brabrand (DK); Niall W.G. Young, Tjele (DK); Graham Bonwick, Cheshire (GB); Christopher Smith, Manchester (GB)

(72) Inventors: Paul Wassell, East Sussex (GB); Mark Farmer, Oron la Ville (CH); Stuart Andrew Warner, Copenhagen K (DK); Allan Torben Bech, Brabrand (DK); Niall W.G. Young, Tjele (DK); Graham Bonwick, Cheshire (GB); Christopher Smith, Manchester (GB)

(73) Assignee: DUPONT NUTRITION BIOSCIENCES APS, Copenhagen K (DK)

(21) Appl. No.: 14/124,934

(22) PCT Filed: Jun. 8, 2012
(86) PCT No.: PCT/GB2012/051294

§ 371 Date: Dec. 9, 2013

Related U.S. Application Data
(60) Provisional application No. 61/497,737, filed on Jun. 16, 2011.

(30) Foreign Application Priority Data
Jun. 9, 2011 (GB) 1109652.6

(51) Int. Cl. A23D 7/00

(52) U.S. Cl. CPC A23D 7/001
USPC 426/604

(57) ABSTRACT

The present invention provides a foodstuff in the form of a spread, wherein the spread is a water in oil emulsion containing
(a) a continuous fat phase
(b) a dispersed aqueous phase,
   wherein the spread comprises
   (i) triglycerides in an amount of from 41 to 90 wt. % based on the foodstuff
   (ii) a mono or di ester of glycerol and Moringa oil.

### CROSS REFERENCE TO RELATED APPLICATIONS

This application claims priority to U.S. Provisional Application No. 61/497,737, filed Jun. 16, 2011. This application is also related to: International Patent Application No. PCT/GB2012/051294, filed Jun. 8, 2012 and Foreign Application No. GB1109652.6, filed Jun. 9, 2011. The entire disclosures of the foregoing applications are hereby incorporated by reference in their entirety for all purposes.

### FIELD OF INVENTION

The present invention relates to a spread. In particular, the present invention relates to a high fat spread comprising an emulsifier derivable from a food source and which is advantageous over prior emulsifiers.

### BACKGROUND

An emulsion is a colloid consisting of a stable mixture of two immiscible phases, typically liquid phases in which small droplets of one phase are dispersed uniformly throughout the other. A typical emulsion is an oil and water emulsion, such as a water-in-oil emulsion. Emulsions may, for example, be industrial emulsions such as water-containing crude oils emulsified by addition of surface active substances, or edible emulsions such as mayonnaise, salad cream or margarine.

Emulsions are typically stabilised by the addition of an emulsifier and many effective emulsifiers are known. A particularly preferred emulsifier for demanding systems is polyglycerol polyricinoleate (PGPR). PGPR is known to be a particularly effective emulsifier. Emulsions, in particular water-in-oil emulsions, prepared with PGPR are typically very stable. However, in many territories legislation prevents the use of PGPR in food products containing 41% fat or more. To overcome these restrictions and to provide stable emulsions those skilled in the art have typically used complex mixtures of monoglycerides. In particular complex mixtures containing monoglycerides having a range of fatty acid types have been selected. The fatty acids of the monoglycerides may be selected based on chain length, degree of unsaturation, position of unsaturation, configuration (cis or trans) of unsaturation and substitution, for example presence of —OH branches. Indeed these multiple variations have often typically been combined. Whilst this selection of monoglycerides may provide the desired properties, the resultant product is both expensive and potentially regarded by consumers as not being natural.

In view of the above, it would be desirable to produce a food or feed containing an emulsifier which does not exhibit such disadvantages when present in a ‘high fat’ system.

### SUMMARY ASPECTS OF THE PRESENT INVENTION

In one aspect, the present invention provides a foodstuff in the form of a spread, wherein the spread is a water in oil emulsion containing

(a) a continuous fat phase
(b) a dispersed aqueous phase,
wherein the spread comprises
(i) triglycerides in an amount of from 41 to 90 wt. % based on the foodstuff
(ii) a mono or di ester of glycerol and Moringa oil.

In one aspect, the present invention provides a process for preparing a foodstuff in the form of a spread, wherein the spread comprises triglycerides in an amount of from 41 to 90 wt. % based on the foodstuff,

comprising the steps of
(a) contacting
(i) a fat phase; and
(ii) an aqueous phase;
   (b) forming an emulsion wherein the fat phase provides a continuous phase and wherein the aqueous phase provides a dispersed phase; and
   (c) contacting the fat phase and the aqueous phase either before step (b) or after step
   (b) with a mono or di ester of glycerol and Moringa oil.

In one aspect, the present invention provides use of a mono or di ester of glycerol and Moringa oil to prepare or stabilise a spread, wherein the spread is a water in oil emulsion containing

(a) a continuous fat phase
(b) a dispersed aqueous phase,
wherein the spread comprises (i) triglycerides in an amount of from 41% to 90 wt. % based on the foodstuff.

It has been surprisingly found that oil from plants from the genus Moringa may be used in the preparation of mono or di esters of glycerol, commonly known to one skilled in the art as mono and di glycerides, which has particular advantages in respect of the stability of emulsions formed by its use as an emulsifier. The present applicants have surprisingly found that an emulsion prepared using the Moringa mono and di glycerides may be sufficiently stable to be used in demanding application. In contrast to the prior art, the product is readily prepared from natural Moringa oil and does not require the blending of a complex mixture of monoglycerides.

It has also been surprisingly found that when preparing spreads with mono and di glycerides of Moringa and glycerol, a spread is provided which is not only stable in use but which also has a firmer and/or more open structure than prior art spreads prepared with mono and di glycerides prepared from other oil sources. These properties may result in a spread which can be used advantageously in a cake making process for forming a whipped cake mixture, pre-baking, which is more airy, i.e. the present product may assist with cake creaming.

As well as being an effective emulsifier, the mono or di ester of glycerol and Moringa oil is particularly advantageous as a source of oil to prepare the mono and di glycerides because the plant has been known as a source of edible materials for many years. Therefore the oil obtained from the plant may be regarded as safe for consumption. The use of mono and di glycerides prepared from Moringa oil has not previously been taught.

Moringa is the sole genus in the flowering plant family Moringaceae. The 13 species it contains are from tropical and subtropical climates and range in size from tiny herbs to very large trees. Moringa may therefore be grown in many climates in which cash crops may not currently be cultivated. Moringa cultivation is promoted as a means to combat poverty and malnutrition and the plant grows quickly in many types of environments. The seeds contain 30-50% oil and may produce 100-200 gal/acre/year. Moringa species are drought-resistant and can grow in a wide variety of poor soils, even barren ground, with soil pH between 4.5 and 9.0.

### DETAILED DESCRIPTION

As discussed above, in one aspect, the present invention provides a foodstuff in the form of a spread, wherein the spread is a water in oil emulsion containing (a) a continuous fat phase (b) a dispersed aqueous phase, wherein the spread comprises (i) triglycerides in an amount of from 41 to 90 wt. % based on the foodstuff, (ii) a mono or di ester of glycerol and Moringa oil.

### Moringa

It will be appreciated by one skilled in the art that the term ‘Moringa’ refers to the sole genus in the flowering plant family Moringaceae.

As discussed in Pandey A., Pradheep, K., Gupta, R., Roshini Nayar, E., Bhandari, D. C., (2010) Drumstick tree, Moringa oleifera Lam, a multipurpose potential species in India, Genetic Resources and Crop Evolution, Springer, the genus Moringa Adans. (family Moringaceae) has more than 13 species (Verdcourt 1985), of which two species viz. M. oleifera Lam. (syn. M. pterygosperma Gaertn.) and M. concanensis Nimmo occur in India. M. oleifera (the drumstick tree, horse radish tree, West Indian Ben) is a fast-growing, medium sized and drought-resistant tree distributed in the sub-Himalayan tracts of northern India (Singh et al. 2000; Hsu et al. 2006). The species of Moringa are further discussed in Bennet, R. N., Mellon, F. A., Foidl, N., Pratt, J. H., DuPont, M. S., Perkins, L., and Kroon, P. A. (2003) “Profiling glucosinolates and phenolics in vegetative and reproductive tissues of the multi-purpose trees. Moringa oleifera L. (horseradish tree) and Moringa stenopetalia L.” Journal of Agricultural and Food Chemistry 51(12) 3546-3553. M. oleifera (locally called shobhanjana, murungai, soanjna, shajna, sainjna) is considered to be the best known and widely distributed tree species among the genus (Morton 1991; Fuglie 1999). This is the only species in this genus which has been accorded some research and development at the world level.

For completeness, the current known species of the plant family Moringaceae are Moringa arborea Verdc. (Kenya), Moringa borziana Mattei, Moringa concanensis Nimmo, Moringa drouhardii Jum.—Bottle Tree (southwestern Madagascar), Moringa hildebrandtii Engl.—Hildebrandt's Moringa (southwestern Madagascar), Moringa longituba Engl., Moringa oleifera Lam. (syn. M. pterygosperma)—Horseradish Tree (northwestern India), Moringa ovalifolia Dinter & Berger, Moringa peregrina (Forssk.) Fiori, Moringa pygmaea Verdc., Moringa ruspoliana Engl., Moringa rivae (Kenya, Ethiopia and Somalia) and Moringa stenopetala (Baker f.) Cufod.

In a preferred aspect the Moringa is a plant of the species Moringa oleifera.

### Mono or Di Ester of Glycerol and Moringa Oil

The process for making mono or di esters of fatty acids and glycerol, in other words mono and diglycerides and the process for making distilled monoglycerides are well known to the person skilled in the art. For example information can be found in “Emulsifiers in Food Technology”, Blackwell Publishing, edited by R. J. Whitehurst, page 40-58.

Mono- and diglycerides are generally produced by interesterification (glycerolysis) of triglycerides with glycerol, see FIG. below:

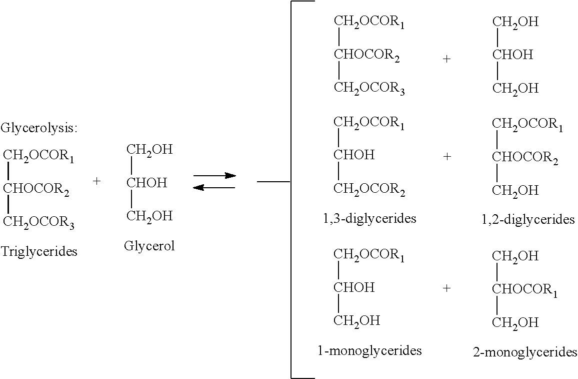

Triglycerides react with glycerol at high temperature (200-250° C.) under alkaline conditions, yielding a mixture of monoglycerides, diglycerides and triglycerides as well as unreacted glycerol. The content of monoglycerides vary typically from 10-60% depending on the glycerol/fat ratio. Alternatively mono- and diglycerides may also be prepared via direct esterification of glycerol with a fatty acid mixture.

If glycerol is removed from the mixture above by e.g. distillation, the resulting mixture of monoglycerides, diglycerides and triglycerides is often sold as a “mono-diglyceride” and used as such. Distilled monoglyceride may be separated from the mono-diglyceride by molecular or short path distillation.

### Usage

The mono or di ester of glycerol and Moringa oil may be provided in the high fat spread in the desired amount to achieve the desired function of the mono or di ester of glycerol and Moringa oil.

In one embodiment, mono or di ester of glycerol and Moringa oil is present in the high fat spread in an amount of at least about 0.01% w/w based on the total weight of the high fat spread. In one embodiment, mono or di ester of glycerol and Moringa oil is present in the high fat spread in an amount of at least about 0.02% w/w based on the total weight of the high fat spread. In one embodiment, mono or di ester of glycerol and Moringa oil is present in the high fat spread in an amount of at least about 0.03% w/w based on the total weight of the high fat spread. In one embodiment, mono or di ester of glycerol and Moringa oil is present in the high fat spread in an amount of at least about 0.04% w/w based on the total weight of the high fat spread. In one embodiment, mono or di ester of glycerol and Moringa oil is present in the high fat spread in an amount of at least about 0.05% w/w based on the total weight of the high fat spread. In one embodiment, mono or di ester of glycerol and Moringa oil is present in the high fat spread in an amount of at least about 0.075% w/w based on the total weight of the high fat spread. In one embodiment, mono or di ester of glycerol and Moringa oil is present in the high fat spread in an amount of at least about 0.1% w/w based on the total weight of the high fat spread. In one embodiment, mono or di ester of glycerol and Moringa oil is present in the high fat spread in an amount of at least about 0.15% w/w based on the total weight of the high fat spread. In one embodiment, mono or di ester of glycerol and Moringa oil is present in the high fat spread in an amount of at least about 0.2% w/w based on the total weight of the high fat spread. In one embodiment, mono or di ester of glycerol and Moringa oil is present in the high fat spread in an amount of at least about 0.3% w/w based on the total weight of the high fat spread. In one embodiment, mono or di ester of glycerol and Moringa oil is present in the high fat spread in an amount of at least about 0.4% w/w based on the total weight of the high fat spread. In one embodiment, mono or di ester of glycerol and Moringa oil is present in the high fat spread in an amount of at least about 0.5% w/w based on the total weight of the high fat spread.

In one embodiment, mono or di ester of glycerol and Moringa oil is present in the high fat spread in an amount of from about 0.01 to about 2.0% w/w based on the total weight of the high fat spread. In one embodiment, mono or di ester of glycerol and Moringa oil is present in the high fat spread in an amount of from about 0.01 to about 1.8% w/w based on the total weight of the high fat spread. In one embodiment, mono or di ester of glycerol and Moringa oil is present in the high fat spread in an amount of from about 0.01 to about 1.5% w/w based on the total weight of the high fat spread. In one embodiment, mono or di ester of glycerol and Moringa oil is present in the high fat spread in an amount of from about 0.05 to about 1.5% w/w based on the total weight of the high fat spread. In one embodiment, mono or di ester of glycerol and Moringa oil is present in the high fat spread in an amount of from about 0.075 to about 1.5% w/w based on the total weight of the high fat spread. In one embodiment, mono or di ester of glycerol and Moringa oil is present in the high fat spread in an amount of from about 0.1 to about 1.5% w/w based on the total weight of the high fat spread. In one embodiment, mono or di ester of glycerol and Moringa oil is present in the high fat spread in an amount of from about 0.1 to about 1.2% w/w based on the total weight of the high fat spread. In one embodiment, mono or di ester of glycerol and Moringa oil is present in the high fat spread in an amount of from about 0.1 to about 1.0% w/w based on the total weight of the high fat spread. In one embodiment, mono or di ester of glycerol and Moringa oil is present in the high fat spread in an amount of from about 0.1 to about 0.8% w/w based on the total weight of the high fat spread. In one embodiment, mono or di ester of glycerol and Moringa oil is present in the high fat spread in an amount of from about 0.1 to about 0.6% w/w based on the total weight of the high fat spread. In one embodiment, mono or di ester of glycerol and Moringa oil is present in the high fat spread in an amount of from about 0.2 to about 0.6% w/w based on the total weight of the high fat spread. In one embodiment, mono or di ester of glycerol and Moringa oil is present in the high fat spread in an amount of from about 0.3 to about 0.6% w/w based on the total weight of the high fat spread.

### High Fat Spread

In addition to providing a high fat spread containing a mono or di ester of glycerol and Moringa oil, the present invention provides a process for preparing the high fat spread. Thus there is provided a process for preparing a foodstuff in the form of a spread, wherein the spread comprises triglycerides in an amount of from 41 to 90 wt. % based on the foodstuff, comprising the steps of (a) contacting (i) a fat phase; and (ii) an aqueous phase; (b) forming an emulsion wherein the fat phase provides a continuous phase and wherein the aqueous phase provides a dispersed phase; and (c) contacting the fat phase and the aqueous phase either before step (b) or after step (b) with a mono or di ester of glycerol and Moringa oil. The emulsion may be a single emulsion, a water in oil emulsion, or the emulsion may be a double emulsion, an oil in water in oil emulsion.

As discussed above it has been found that the present invention is particularly advantageous because the mono or di ester of glycerol and Moringa oil has particular advantages in respect of the stability of emulsions formed by its use as an emulsifier. The present applicants have surprisingly found that an emulsion prepared using the Moringa mono and di glycerides may be sufficiently stable to be used in demanding application but which is not overly stable. Thus if it is desired, the emulsion may be separated into its component phases. Thus in a further aspect the present invention provides use of a mono or di ester of glycerol and Moringa oil to prepare a food or feed emulsion wherein the emulsion may be separated into its constituent phases.

In the process of the preset invention the mono or di ester of glycerol and Moringa oil may be added to the (i) fat phase; and (ii) aqueous phase by addition any suitable route For example the mono or di ester of glycerol and Moringa oil may be added to one or both of the (i) fat phase; and (ii) aqueous phase prior to the contact of the (i) fat phase; and (ii) aqueous phase and thereby be present on contact of the (i) fat phase; and (ii) aqueous phase. Alternatively, the mono or di ester of glycerol and Moringa oil may be added to the (i) fat phase; and (ii) aqueous phase once they have been combined or as they are combined. In one aspect the mono or di ester of glycerol and Moringa oil is present in the fat phase of step (a).

As discussed herein, the spread contains triglycerides in an amount of from 41 to 90 wt. % based on the foodstuff. Such a spread is commonly referred to as a high fat spread. In one aspect, the spread contains triglycerides in an amount of from 41 to 85 wt. % based on the foodstuff. In one aspect, the spread contains triglycerides in an amount of from 41 to 80 wt. % based on the foodstuff. In one aspect, the spread contains triglycerides in an amount of from 41 to 75 wt. % based on the foodstuff. In one aspect, the spread contains triglycerides in an amount of from 41 to 70 wt. % based on the foodstuff. In one aspect, the spread contains triglycerides in an amount of from 50 to 70 wt. % based on the foodstuff. In one aspect, the spread contains triglycerides in an amount of from 55 to 70 wt. % based on the foodstuff. In one aspect, the spread contains triglycerides in an amount of from 55 to 65 wt. % based on the foodstuff.

In respect of double emulsions the present invention is further advantageous because long chain fatty acids and/or essential oils present in the double emulsion are effectively encapsulated by the emulsion provided by the Moringa monoglyceride. This degree of encapsulation protects the long chain fatty acids and/or essential oils from degradation. Yet further, we have found that the because of the high affinity of the Moringa monoglyceride for water, similar to the high affinity shown by polyglycerol polyricinoleic acid (PGPR) for water, the Moringa monoglyceride can exhibit PGPR like properties in double emulsions, for example the Moringa monoglyceride may protect salt and the like held within an internal water phase.

As discussed herein, the present invention provides a spread which is highly stable but yet which can be reworked. Typically, in the field of spreads, the emulsifier of choice for the preparation of highly stable spreads is polyglycerol polyricinoleic acid (PGPR). As discussed herein, the Moringa monoglyceride of the present invention provides an alternative to PGPR but does not suffer from the disadvantage of being too stable such that it can not separated if this desired. Thus in one preferred aspect, the spread is free of polyglycerol polyricinoleic acid. It will be understood that by the term ‘free of polyglycerol polyricinoleic acid’ it is meant that the spread contains polyglycerol polyricinoleic acid in an amount of less than 0.01 wt. %, preferably the spread contains polyglycerol polyricinoleic acid in an amount of less than 0.001 wt. %, preferably the spread contains polyglycerol polyricinoleic acid in an amount of less than 0.0001 wt. %, preferably the spread contains polyglycerol polyricinoleic acid in an amount of less than 0.00001 wt. %, preferably the spread contains polyglycerol polyricinoleic acid in an amount of 0 wt. %.

The spread of the present invention may be used in any manner desired by the end user. In one aspect, the spread may be used in the preparation of a cake batter. In this aspect the present invention provides a process for preparing a cake batter, comprising the steps of

(A) mixing the cake batter ingredients with a spread,
wherein the spread is a water in oil emulsion containing
   (a) a continuous fat phase
   (b) a dispersed aqueous phase,
wherein the spread comprises
   (i) triglycerides in an amount of from 41 to 90 wt. % based on the spread
   (ii) a mono or di ester of glycerol and Moringa oil.
      (B) optionally whipping the mixture of step (A).

### BRIEF DESCRIPTION OF FIGURES

FIG. 1 shows a graph;

FIGS. 2 to 7 show images;

FIGS. 8, 9 and 10 show graphs;

FIGS. 11 and 12 show images; and

FIG. 13 shows a graph.

### EXAMPLES

The present invention will now be defined with reference to the following non-limiting examples.

### Example

The present example demonstrates that addition of Moringa monoglycerides into high fat spreads leads to stable commercially acceptable products. In contrast addition into the same products of monoglycerides prepared with oil from plants of the genus Lesquerella results in product failure. The behaviour of Moringa is endorsed by water droplet size distribution analysis, confocal microscopy, texture and sensory analysis, all indicating Moringa's functional activity.

Monoglycerides prepared with oil from plants of the genus Lesquerella were selected for the purposes of comparison because plants of the genus Lesquerella provide fatty acids similar to the fatty acids of Moringa. In particular Lesquerella oil is hydroxy fatty acid triglyceride wherein the fatty acid has a chain length of 20 carbon atoms. The fatty acid is predominantly lesquerolic acid (14-Hydroxy-cis-11-eicosenoic acid).

### Materials & Methods

The Moringa monoglyceride and distilled Moringa monoglyceride were prepared in several batches in accordance with the processes described below.

2472/173: Mono-Diglyceride Based on Moringa Oil. Interesterification.

### (Mono-Diglyceride 173; Moringa Mono-Diglyceride 173; Moringa 173; MM 173)

Refined moringa oil (Code: 126089, Batch Nr: DEO5040243, EO Ref: SO4903823/1, from Earth Oil Plantations Limited). 2550 g. The moringa oil was extracted from Moringa oleifera (also known as Moringa pterygosperma).

Glycerol 625 g.

1.300 g 50% solution of NaOH.

Above ingredients were charged to a 5 L 3-necked round bottomed flask, with mechanical stirring, heating mantel with temperature control, nitrogen blanketing, condenser, in a set-up analogous to the below example:

The temperature was raised to 240° C. under stirring and nitrogen blanketing. The mixture was heated at 240° C. until it becomes clear. When clear, the mixture was heated for further 30 min.

The mixture was then neutralised with 1.25 g H₃PO₄ (85%) at 240° C. After neutralisation the mixture was cooled to about 90° C.

The mixture was deodorised in order to remove the free glycerol. The set-up around the 3-necked flask was therefore changed to look like the below example of a deodorisation set-up:

Water vapours were introduced to the mixture via a glass tube at the bottom of the 3 necked flask below surface level of the mixture, a cold trap cooled by acetone/CO₂ bath was used and connected to a vacuum pump.

At 90° C. full vacuum (<0.5 mm Hg) was supplied to the set-up from the vacuum pump. This caused thorough mixing of the product mixture. Then the mixture was heated to 140° C. and kept at this temperature for 30 min. Water vapours were passing through the mixture thereby removing free glycerol which is condensed on the cold trap and collected in the receiver flask.

After 30 min the product as cooled to 90° and pressure equalised with nitrogen.

Optionally the filtered mono-diglyceride can be protected with antioxidants if the mono-diglyceride is the end product. Antioxidants were added and the mixture stirred for 15-30 min under nitrogen blanketing at 80-90° C.

Yield 2870 g.

The mono-diglyceride was filtered through filteraid (Clarcell) and paper filter (AGF 165-110).

### 2472/191: Distilled Monoglyceride Based on Moringa Oil.

### (Mono-Diglyceride 191; Moringa Mono-Diglyceride 191; Moringa 191; MM 191)

Mono-diglyceride (2472/173) 2480 g.

The mono-diglyceride was distilled on a short path distillation apparatus.

The distillation temperature was 210° C.

Reservoir temp. before heated surface 85° C.

Condenser was 85° C.

Rotor speed 302 rpm.

Pressure: 1×10⁻³ mBar

Distillate 1373 g

Residue 1107 g

Time 212 min.

Flow: 701 g/h

The distillate was added antioxidant Grindox 349 0.68 g.

Analysis of the distilled monoglyceride determined by GC:

TABLE 1
composition of monoglyceride based on moringa oil

| | % |
|---|---|
| Glycerol | 0.76 |
| Diglycerol | 0.07 |
| Monoglyceride | 91.15 |
| Diglyceride | 7.75 |
| Triglyceride | 0.00 |

The fatty acid composition of both the starting material, moringa oil, and the resulting monoglyceride was also analysed:

TABLE 2
Fatty acid composition of moringa
oil and the resulting monoglyceride.

| | Triglyceride | Monoglyceride |
|---|---|---|
| | (moringa oil) | 2472/191 |
| C12 | 0.2 | <0.1 |
| C14 | 0.1 | 0.1 |
| C15 | <0.1 | <0.1 |
| C16 | 5.9 | 6.5 |
| C16:1 | 1.8 | 1.8 |
| C18 | 5.5 | 5.8 |
| C18:1 | 71.8 | 71.2 |
| C18:2 | 1.6 | 1.5 |
| C18:3 | 0 | 0.3 |
| C20 | 3.3 | 3.4 |
| C20:1 | 1.9 | 1.9 |
| C22 | 6.3 | 6.0 |
| C24 | 1.0 | 0.8 |

This analysis was done in order to confirm that the fatty acid composition of the monoglyceride had not changed too much from the starting material.

Moringa oil contains 10-12% of saturated fatty acids above C18. In order to keep these high melting fatty acids in the distilled monoglyceride the distillation temperature had to be chosen sufficiently high such that these at least were distilled. As can be seen from the above table this was accomplished. Transferring the highest boiling monoglyceride components however results in the monoglyceride as such having a higher content of diglyceride than is usually seen with distilled monoglycerides, but that is merely a consequence of the broad fatty acid composition in the moringa oil, and that the heavier monoglycerides were prioritised due to their also higher melting points.

2559/102: Mono-Diglyceride Based on Moringa Oil. Interesterification.

### (Mono-Diglyceride 102; Moringa Mono-Diglyceride 102; Moringa 102; MM 102)

Refined moringa oil (Code: 126089, Batch Nr: DEO5040243, EO Ref: SO4903823/1, from Earth Oil Plantations Limited). 2072 g.

Glycerol 518 g

1.082 g 50% solution of NaOH

The experiment was carried out as for above interesterification (2472/173).

After the interesterification, the mixture was neutralised with 1.04 g H₃PO₄ (85%) at 240° C. After neutralisation the mixture was cooled to about 90° C. and the mixture was deodorised and filtered as for above interesterification (2472/173).

Yield: 2313 g.

Analysis of mono-diglyceride:

TABLE 3
Composition of mono-diglyceride based on moringa oil

| | % |
|---|---|
| Glycerol | 0.11 |
| Diglycerol | 0.05 |
| Free fatty acids | 0.2 |
| Monoglyceride | 53.16 |
| Diglyceride | 42.05 |
| Triglyceride | 4.39 |

2559/103: Mono-Diglyceride Based on Moringa Oil. Interesterification

### (Mono-Diglyceride 103; Moringa Mono-Diglyceride 103; Moringa 103; MM 103) (Repetition of 2559/102)

Refined moringa oil (Code: 126089, Batch Nr: DEO5040243, EO Ref: SO4903823/1, from Earth Oil Plantations Limited). 2146 g.

Glycerol 537 g

1.110 g 50% solution of NaOH

The experiment was carried out as for above interesterification (2472/173).

After the interesterification, the mixture was neutralised with 1.07 g H₃PO₄ (85%) at 240° C. After neutralisation the mixture was cooled to about 90° C. and the mixture was deodorised and filtered as for above interesterification (2472/173).

Yield: 2412 g.

Analysis of mono-diglyceride:

TABLE 4
Composition of mono-diglyceride based on moringa oil

| | % |
|---|---|
| Glycerol | 0.16 |
| Diglycerol | 0.02 |
| Free fatty acids | 0.3 |
| Monoglyceride | 54.85 |
| Diglyceride | 39.59 |
| Triglyceride | 5.06 |

### 2559/104: Distilled Monoglyceride Based on Moringa Oil

### (Mono-Diglyceride 104; Moringa Mono-Diglyceride 104; Moringa 104; MM 104)

The mono-diglyceride was distilled on a short path distillation apparatus as above (2472/191).

Mono-diglyceride (2559/102)+(2559/103) were both distilled.

The distillation temperature was 200-210° C.

Reservoir temp. before heated surface 85° C.

Condenser was 90° C.

Rotor speed 297 rpm.

Pressure: 4−5×10⁻³ mBar

Distillate 2245 g

Residue 1819 g

Time 360 min.

Flow: 677 g/h

Analysis of distilled monoglyceride determined by GC:

TABLE 5
Composition of monoglyceride based on moringa oil

| | % |
|---|---|
| Glycerol | 1.27 |
| Diglycerol | 0.08 |
| Free fatty acids | 0.4 |
| Monoglyceride | 82.55 |
| Diglyceride | 15.67 |
| Triglyceride | 0.02 |

2559/105: Distilled Monoglyceride Above Based on Moringa Oil with Added Antioxidant.

### (Mono-Diglyceride 105; Moringa Mono-Diglyceride 105; Moringa 105; MM 105)

2559/104: 2245 g

Grindox 349: 1.12 g

### 2559/132: Distilled Monoglyceride Based on Moringa Oil.

### (Mono-Diglyceride 132; Moringa Mono-Diglyceride 132; Moringa 132; MM 132)

Mono-diglyceride prepared analogously to above mono-diglycerides (2472/173) and with the following analysis were used as raw material for the distillation.

TABLE 6
Composition of mono-diglyceride used
as raw material for distillation.

| | % |
|---|---|
| Glycerol | 0.16 |
| Diglycerol | 0.13 |
| Free fatty acids | 0.2 |
| Monoglyceride | 55.39 |
| Diglyceride | 39.50 |
| Triglyceride | 4.65 |

The mono-diglyceride was distilled on a short path distillation apparatus as above (2472/191).

The distillation temperature was 210° C.

Reservoir temp. before heated surface 85° C.

Condenser was 85° C.

Rotor speed 297 rpm.

Pressure: 1−2×10⁻³ mBar

Distillate 1506 g

Residue 1092 g

Time 211 min.

Flow: 739 g/h

Analysis of distilled monoglyceride determined by GC:

TABLE 7
Composition of monoglyceride based on moringa oil

| | % |
|---|---|
| Glycerol | 0.88 |
| Diglycerol | 0.15 |
| Free fatty acids | 0.2 |
| Monoglyceride | 86.92 |
| Diglyceride | 11.80 |
| Triglyceride | 0.03 |

### 2559/134: Distilled Monoglyceride Based on Moringa Oil.

### (Mono-Diglyceride 134; Moringa Mono-Diglyceride 134; Moringa 134; MM 134)

Mono-diglyceride prepared analogously to above mono-diglycerides (2472/173) and with the following analysis were used as raw material for the distillation.

TABLE 8
Composition of mono-diglyceride used
as raw material for distillation.

| | % |
|---|---|
| Glycerol | 0.49 |
| Diglycerol | 0.11 |
| Free fatty acids | 0.2 |
| Monoglyceride | 54.51 |
| Diglyceride | 39.78 |
| Triglyceride | 4.92 |

The mono-diglyceride was distilled on a short path distillation apparatus as above (2472/191).

The distillation temperature was 185° C.

Reservoir temp. before heated surface 85° C.

Condenser was 85° C.

Rotor speed 290 rpm.

Pressure: 1−2×10⁻³ mBar

Distillate 1407 g

Residue 1444 g

Time 223 min.

Flow: 767 g/h

Analysis of distilled monoglyceride determined by GC:

TABLE 9
Composition of monoglyceride based on moringa oil.

| | % |
|---|---|
| Glycerol | 0.52 |
| Diglycerol | 0.22 |
| Free fatty acids | 0.2 |
| Monoglyceride | 97.98 |
| Diglyceride | 1.06 |
| Triglyceride | 0.02 |

A summary of the analysis of samples 2559/132 and 2559/134 is given in Table 10 below.

TABLE 10

| | Monoglyceride | Monoglyceride | |
|---|---|---|---|
| | 2559/132 | 2559/134 | Triglyceride |
| Distillation ° C. | 210° C. | 185° C. | starting material |
| GL | 0.88 | 0.52 | |
| DIGL | 0.15 | 0.22 | |
| FFA | 0.2 | 0.2 | |
| MONO | 86.92 | 97.95 | |
| DI | 11.80 | 1.06 | |
| TRI | 0.03 | 0.02 | |
| C12 | <0.1 | <0.1 | 0.2 |
| C14 | 0.1 | 0.1 | 0.1 |
| C16 | 6.3 | 6.4 | 5.9 |
| C16:1 | 1.9 | 1.9 | 1.8 |
| C17 | 0.1 | 0.1 | 0.1 |
| C18 | 5.5 | 5.7 | 5.5 |
| C18:1 | 72.6 | 75.3 | 71.8 |
| C18:2 | 1.5 | 1.5 | 1.6 |
| C18:3 | 0.2 | 0.2 | 0.0 |
| C20 | 3.2 | 2.9 | 3.3 |
| C20:1 | 1.8 | 1.7 | 1.9 |
| C20:u | 0.2 | 0.2 | 0.1 |
| C21 | <0.1 | 0.0 | |
| C22 | 5.8 | 3.6 | 6.3 |
| C22:1 | 0.1 | 0.0 | 0.1 |
| C23 | <0.1 | <0.1 | 1.0 |
| C24 | 0.8 | 0.3 | 0.1 |

2461/206: Mono-Diglyceride Based on Moringa Oil. Interesterification.

Refined moringa oil (Code: 126089, Batch Nr: DEO5040243, EO Ref: SO4903823/1, from Earth Oil Plantations Limited). 3000 g.

Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C. After neutralisation the mixture was cooled to about 90° C. and the mixture was deodorised and filtered as for above interesterification (2472/173).

Yield: 3751 g.

Analysis of mono-diglyceride:

Composition of mono-diglyceride based on moringa oil

| | % |
|---|---|
| Glycerol | 0.2 |
| Diglycerol | <0.1 |
| Free fatty acids | 0.2 |
| Monoglyceride | 54.0 |
| Diglyceride | 40.5 |
| Triglyceride | 5.1 |

2461/207: Mono-Diglyceride Based on Moringa Oil. Interesterification (Repetition of 2461/206)

Refined moringa oil (Code: 126089, Batch Nr: DEO5040243, EO Ref: SO4903823/1, from Earth Oil Plantations Limited). 3000 g.

Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C. After neutralisation the mixture was cooled to about 90° C. and the mixture was deodorised and filtered as for above interesterification (2472/173).

Yield: 3751 g.

Analysis of mono-diglyceride:

Composition of mono-diglyceride based on moringa oil

| | % |
|---|---|
| Glycerol | 0.5 |
| Diglycerol | <0.1 |
| Free fatty acids | 0.3 |
| Monoglyceride | 52.0 |
| Diglyceride | 41.9 |
| Triglyceride | 5.3 |

### 2461/208: Distilled Monoglyceride Based on Moringa Oil.

The mono-diglycerides 2461/206+2461/208 was distilled on a short path distillation apparatus as above (2472/191).

The distillation temperature was 210° C.

Reservoir temp. before heated surface 85° C.

Condenser was 80° C.

Rotor speed 300 rpm.

Pressure: 2×10⁻³ mBar

Distillate 3750 g

Residue 2711 g

Time 540 min.

Flow: 718 g/h

Analysis of distilled monoglyceride determined by GC:

Composition of monoglyceride based on moringa oil

| | % |
|---|---|
| Glycerol | 1.2 |
| Diglycerol | 0.1 |
| Free fatty acids | 0.1 |
| Monoglyceride | 83.5 |
| Diglyceride | 15.2 |
| Triglyceride | 0.1 |

The distilled monoglyceride was protected with antioxidant: Grindox 349: 1.87 g

### Distilled Monoglyceride Based on Lesquerella Oil.

The monoglycerides prepared with oil from plants of the genus Lesquerella were prepared in accordance with the processes well known to the person skilled in the art. and described in “Emulsifiers in Food Technology”, Blackwell Publishing, edited by R. J. Whitehurst, page 40-58. The analysis of the samples is given below in Table 13.

### Spreads

The spread samples were made as described below.

### Water Phase:

1. Mix tap water (10-20° C.), potassium sorbate, EDTA, salt and protein on stirring device for approx. 1 min.
2. Adjust pH with citric acid or NaOH
3. Add flavour just before running perfector

### Fat Phase:

1. Weigh out emulsifier, beta carotene (2% solution) and oil/fat in the same container

### 2. Heat to 80° C.

3. Stir the fat phase until mixed well
4. Cool the fat phase to 50°-60° C.
5. Add flavour just before running the Perfector

### Emulsion:

Add the water phase to the fat phase while stirring

Process conditions

| | |
|---|---|
| Emulsion temperature | 40°-55° C. (water 20° C. and fat 50°-60° C.) |
| Capacity | 50 kg/h |
| Cooling | 2 tubes |
| (NH₃ temperature) | −15° C. to −20° C. |
| RPM | 600-1000 |
| Additional processing | may be necessary (for example pinning machine) |
| Outlet temperature | 10°-20° C. |

The full recipe and processing conditions are given below for 60% fat spreads in Tables 11 and 12.

TABLE 11
Recipe for 60% fat spreads trials 1-6 from journal no. DK-16429
Ingredients in %

| | | | | | | |
|---|---|---|---|---|---|---|
| Ingredient Name | 1 | 2 | 3 | 4 | 5 | 6 |

Water phase

| | | | | | | |
|---|---|---|---|---|---|---|
| Water (Tap) | 38.400 | 38.400 | 38.400 | 38.400 | 38.400 | 38.400 |
| Salt | 1.000 | 1.000 | 1.000 | 1.000 | 1.000 | 1.000 |
| Skimmed milk powder (MILEX 240) | 0.500 | 0.500 | 0.500 | 0.500 | 0.500 | 0.500 |
| Potassium Sorbate | 0.100 | 0.100 | 0.100 | 0.100 | 0.100 | 0.100 |
| Water phase total | 40.000 | 40.000 | 40.000 | 40.000 | 40.000 | 40.000 |
| pH | 5.5 | 5.5 | 5.5 | 5.5 | 5.5 | 5.5 |

Fat phase
Fat blend

| | | | | | | |
|---|---|---|---|---|---|---|
| PK4-INES | 25.000 | 25.000 | 25.000 | 25.000 | 25.000 | 25.000 |
| Rapeseed oil | 75.000 | 75.000 | 75.000 | 75.000 | 75.000 | 75.000 |
| Fat blend total | 100.000 | 100.000 | 100.000 | 100.000 | 100.000 | 100.000 |

Other fat ingredients

| | | | | | | |
|---|---|---|---|---|---|---|
| Distilled Monoglyceride, Lesquerella Oil, RBD | | | | | 0.300 | 0.600 |
| DIMODAN R-T PEL/B-K | 0.300 | 0.600 | | | | |
| Monoglyceride, Moringa Oil | | | 0.300 | 0.600 | | |
| TOCO 50 | 0.010 | 0.010 | 0.010 | 0.010 | 0.010 | 0.010 |
| 2% sol. beta-carotene | 0.020 | 0.020 | 0.020 | 0.020 | 0.020 | 0.020 |
| Other fat ingredients total | 0.330 | 0.630 | 0.330 | 0.630 | 0.330 | 0.630 |
| Fat phase total | 60.000 | 60.000 | 60.000 | 60.000 | 60.000 | 60.000 |
| RECIPE total (calc. batchsize) | 100.000 | 100.000 | 100.000 | 100.000 | 100.000 | 100.000 |

PK4-INES is an interesterified mixture of 60% palm stearine and 40% palm kernel available from Cargill GmbH., Hamburg, Germany
DIMODAN R-T PEL/B is a distilled monoglyceride prepared from partially hydrogenated rape seed oil available from DuPont (former Danisco A/S), Denmark.
TOCO 50 is an antioxidant which is a natural identity preserved tocopherol with a selected identity preserved food grade oil as a carrier available from DuPont (former Danisco A/S), Denmark

The samples according to Table 11 are as follows;

### 1 DIMODAN® RT 0.3%

### 2 DIMODAN® RT 0.6%

3 Moringa monoglyceride (MM 191) 0.3%
4 Moringa monoglyceride (MM 191) 0.6%
5 Lesquerella monoglyceride 0.3%
6 Lesquerella monoglyceride 0.6%

The fatty acid distribution of the Lesquerella monoglyceride is given in Table 13 and the fatty acid distribution of the Moringa monoglyceride is given in Table 14.

TABLE 12
Pilot plant processing conditions for the 60%
fat spread samples, journal no. DK-16249.

| Pilot Plant | |
|---|---|
| Processing (3-tube lab perfector): | |
| Oil temperature | 50 |
| Water phase temperature | 20 |
| Emulsion temperature | 50 |
| Centrifugal pump | Auto |
| Capacity high | 40 |
| Cooling (NH3) tube 1: | −10 |
| Cooling (NH3) tube 2: | −10 |
| Cooling (NH3) tube 3: | −10 |
| Rpm tube 1: | 1000 |
| Rpm tube 2: | 1000 |
| Rpm tube 3: | 1000 |

TABLE 13
fatty acid distribution and analysis of
Lesquerella oil and monoglyceride

| Analysis | |
|---|---|
| | Lesquerella oil |
| C₁₄ | <0.1 |
| C₁₆ | 1.5 |
| C_{16:1} | 0.6 |
| C₁₈ | 1.9 |
| C_{18:1} | 14.9 |
| C_{18:2} | 9.5 |
| C_{18:3} | 11.1 |
| C₂₀ | 0.2 |
| C_{20:1} | 0.9 |
| Densipolic oil | 0.4 |
| Ricinoleic oil | 0.6 |
| Lesquerolic acid | 55.2 |
| Auricolic acid | 3.2 |
| AV | 5.0 |
| SAV | 175.7 |
| OHV | 96.9 |
| Iodine number | 107.8 |
| POV | 1.87 |
| Colour Lovibond 5% | 6.9 |
| Red | 2.9 |
| Yellow | 40 |
| | Distilled Mono Lesquerella |
| Glycerol | 0.2% |
| FFA (16-18) | 0.3% |
| FFA (C₂₀ —OH) | 0.4% |
| Monoglyceride | 93.0% |
| Diglyceride | 8.1% |
| Triglyceride | — |
| Total | 100% |

TABLE 14
showing fatty acid profiles for MM191
MM191

| | |
|---|---|
| C₁₀ | <0.1 |
| C₁₂ | 0.1 |
| C₁₄ | 0.1 |
| C₁₅ | <0.1 |
| C₁₆ | 5.3 |
| C_{16:1} | 0.1 |
| C₁₇ | 0.1 |
| C₁₈ | 10.9 |
| C_{18:1} | 64.6 |
| C_{18:2} | 5.2 |
| C_{18:3} | 0.0 |
| C₂₀ | 1.3 |
| C_{20:1} | 1.4 |
| C_{20:unsaturated} | 0.1 |
| C₂₂ | 10.7 |
| C_{22:1} | 0.0 |
| C_{22:unsaturated} | 0.0 |
| C₂₄ | 0.3 |
| C_{24:1} | 0.0 |

### Results & Discussion

### 60% Fat Spreads

Table 15 shows the water droplet size distribution for the samples from 60% fat spreads based on those trials shown in Table 11.

TABLE 15
Water droplet size distribution for 60% fat spread samples.

| Sample | 2_5% < μm | 50% < μm | 97_5% < μm |
|---|---|---|---|
| DIMODAN ® RT 0.3% | 0.92 | 3.24 | 11.43 |
| St. Dev | 0.04 | 0.09 | 1.06 |
| DIMODAN ® RT 0.6% | 1.79 | 2.80 | 4.39 |
| St. Dev | 0.18 | 0.06 | 0.25 |
| Moringa 0.3% | 1.59 | 6.36 | 25.44 |
| St. Dev | 0.04 | 0.06 | 1.07 |
| Moringa 0.6% | 1.46 | 4.38 | 13.14 |
| St. Dev | 0.06 | 0.12 | 1.22 |
| Lesquerella 0.3% | 1.63 | 17.90 | 212.35 |
| St. Dev | 0.24 | 3.43 | 115.68 |
| Lesquerella 0.6% | 2.27 | 26.59 | 312.09 |
| St. Dev | 0.09 | 0.82 | 7.18 |

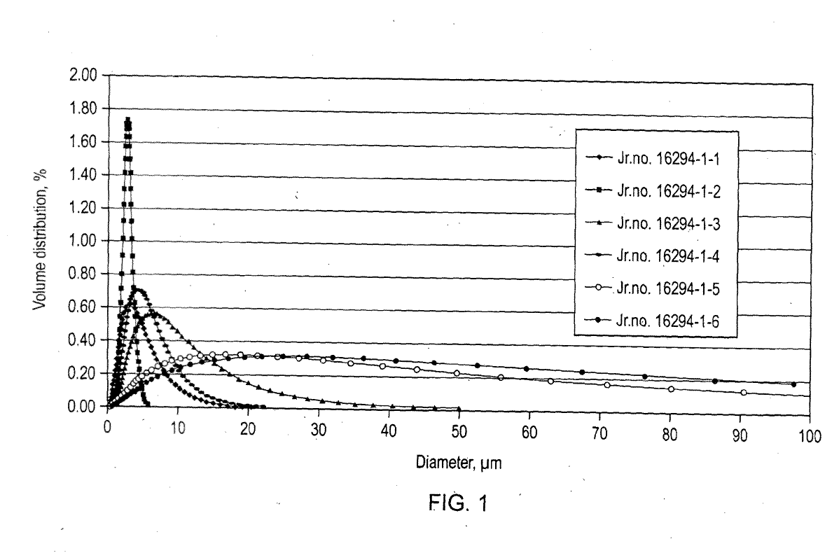

Interestingly the samples for Lesquerella, despite the high fat concentration did not show any kind of small water droplet. Rather the contrary, the figures here suggest large lakes of water. This assumption is further supported by the data of the distribution as expressed graphically—see FIG. 1.

Clearly visible in FIG. 1 is the distribution of the water droplet sizes for the 60% fat spreads, showing the extremely large size of those water droplets corresponding to Lesquerella. Concentrating though on Moringa, sample 4 at the concentration of 0.6% is showing a water droplet size broadly akin to that of sample 1 which corresponds to DIMODAN® RT at 0.3%. This is sufficient to suggest that the stability of the 0.6% Moringa product is likely to be good and approach that of the DIMODAN® RT 0.3% sample.

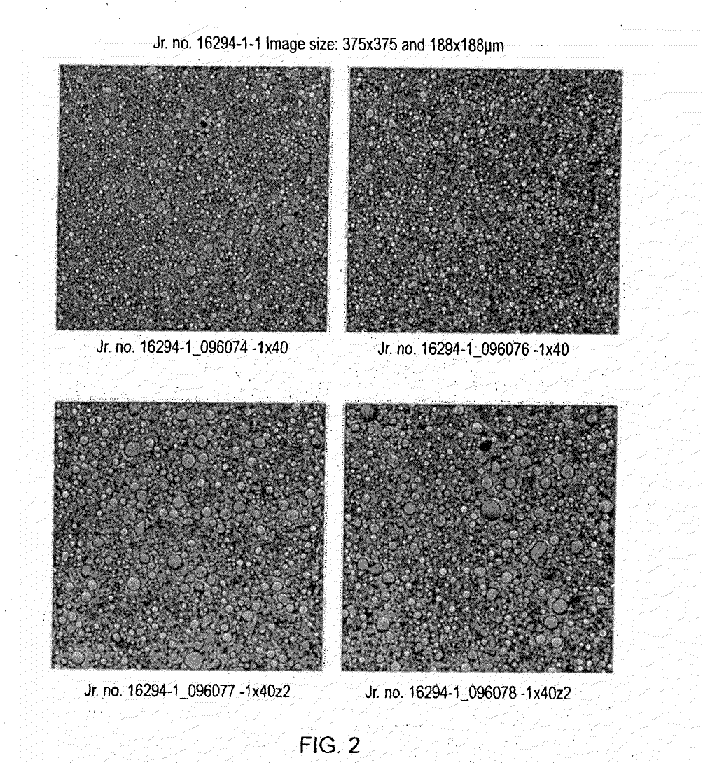

The data presented in FIGS. 2 to 7 are the confocal microscope images of trials 1-6 from Table 11.

FIGS. 2 to 7 present excellent visual images to support the data in FIG. 1. It is clear to see that the DIMODAN® RT 0.3% and 0.6% samples have a small water droplet size and a narrow water droplet distribution. One could predict that the DIMODAN®RT sample at 0.6% would have a much harder structure and the texture would be less spreadable than the sample at 0.3% concentration. Sensory properties are reported below.

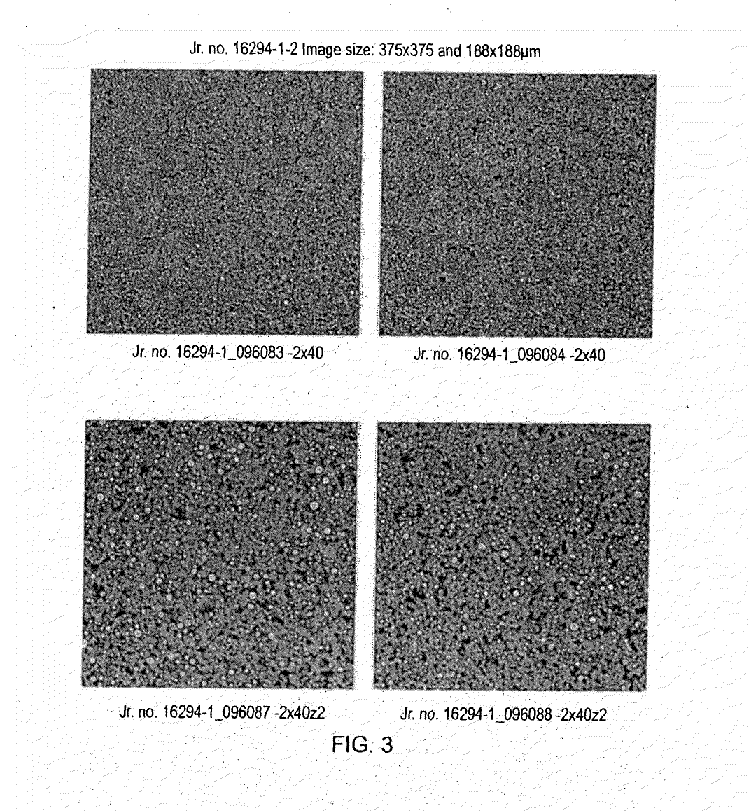

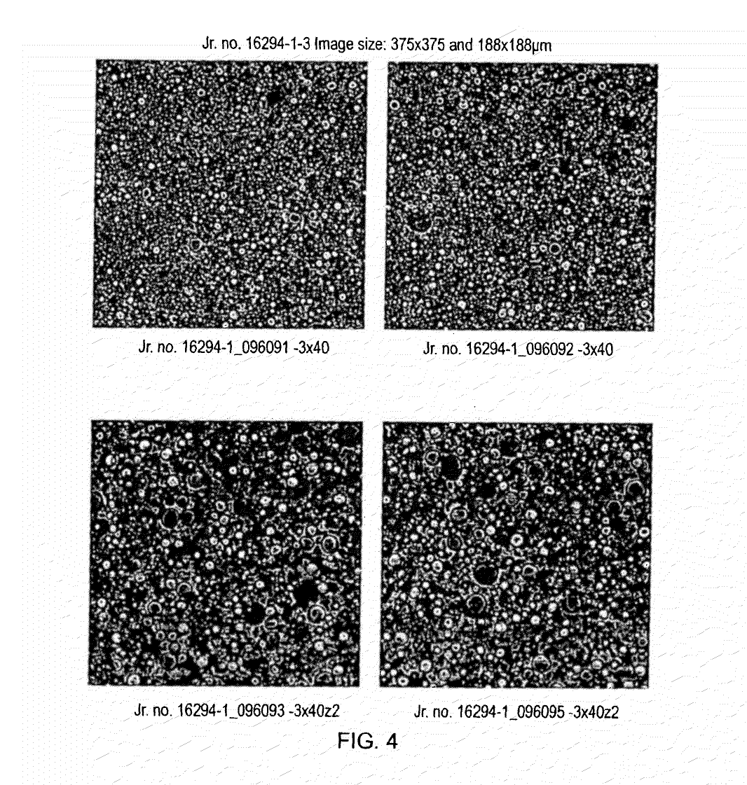

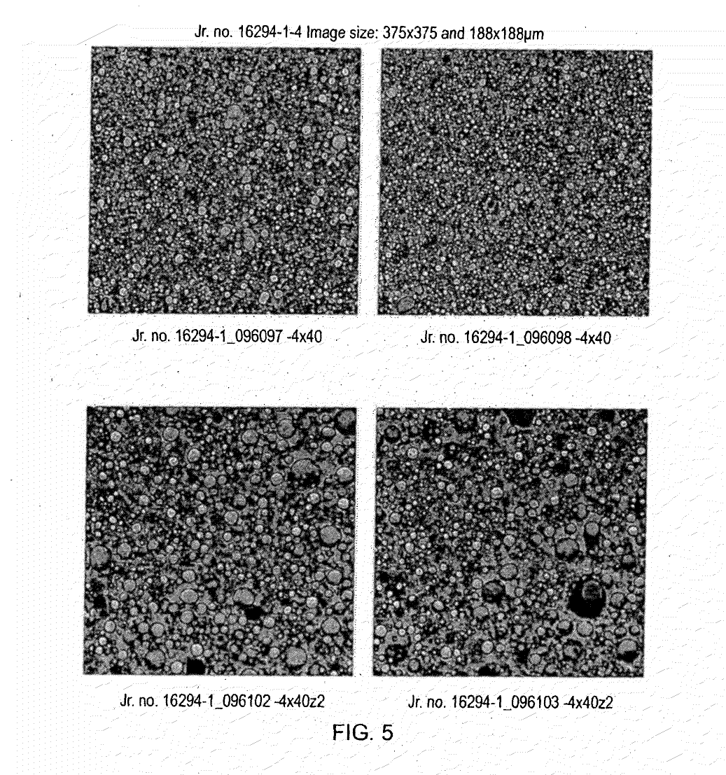

FIGS. 4 and 5 refer to the samples with Moringa at 0.3 and 0.6% respectively, and it can be seen that the water droplet size is considerably larger in FIG. 4 at 0.3% as opposed to 0.6%—FIG. 5. None of these Figures show the tight level of structure as that of FIG. 3 (DIMODAN® RT 0.6%), but for FIG. 5, where Moringa is at 0.6% concentration the confocal images are similar to those for DIMODAN® RT at 0.3%. This is also indicated in the graphical data shown in FIG. 1, and indicates that Moringa here is behaving in a manner that is capable of forming stable spread products and this high fat concentration in parity with DIMODAN® RT—albeit at a higher concentration.

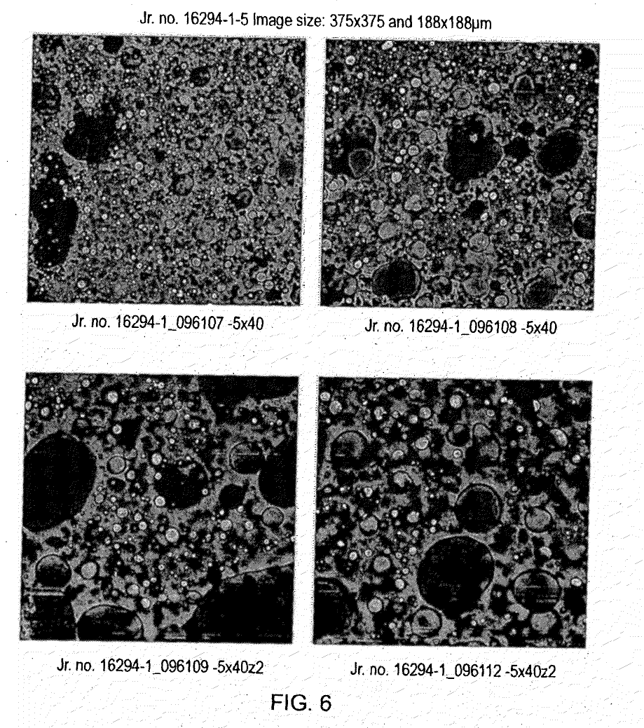

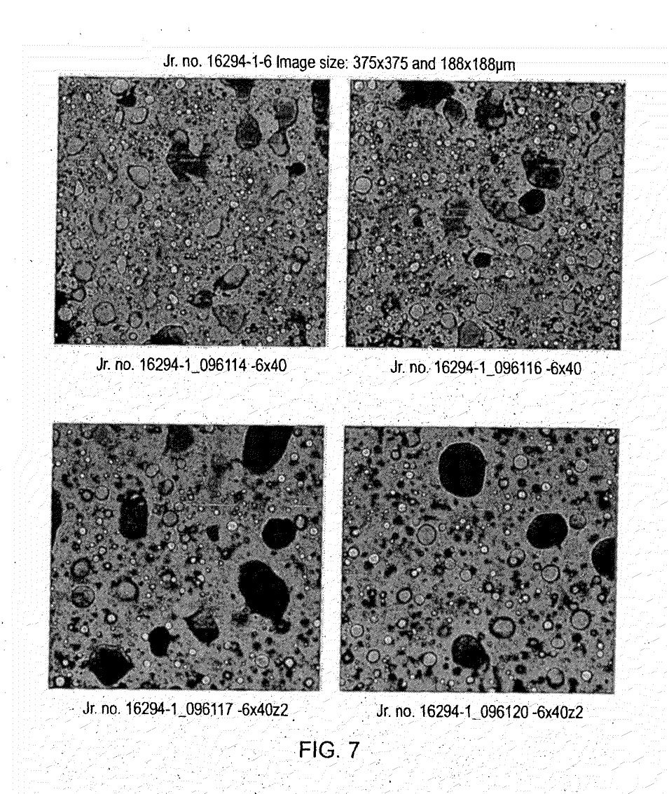

FIGS. 6 and 7, corresponding to Lesquerella at 0.3 and 0.6% respectively show the presence of large areas of coalesced water droplets. This is enough to confirm that this product is not stable and basically would fail any storage or spreading test post production. For samples of equally high water droplet size, similar conclusions have been drawn. It is easy to conclude that for 60% fat spread systems the use of Lesquerella is not recommended.

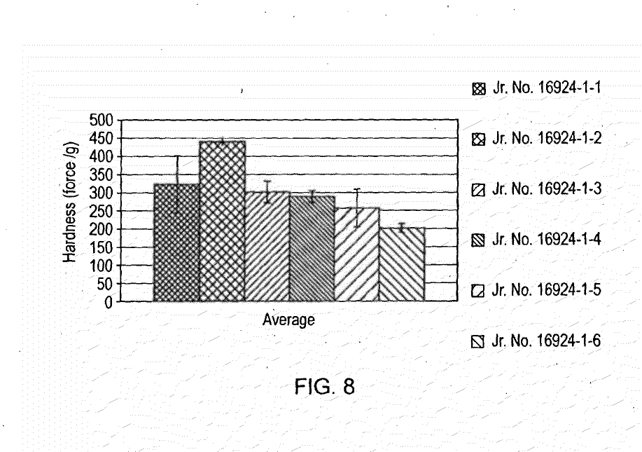

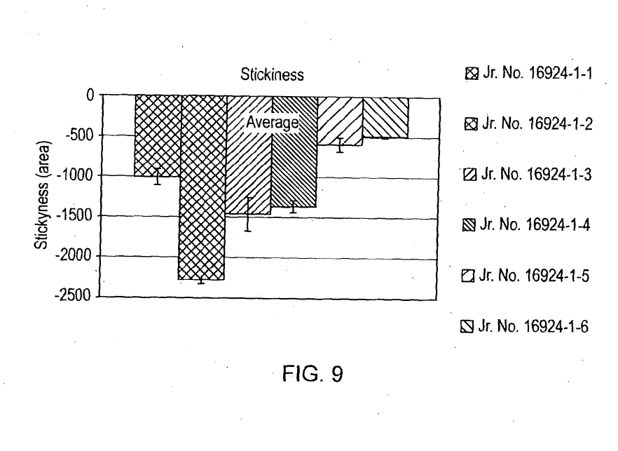

The texture of the spread samples was measured and treated together and shown in FIG. 8 (hardness) and FIG. 9 (stickiness). Considering the high fat samples it is clear that the DIMODAN® RT spreads result in the greatest degree of hardness, but with the exception of sample 2 where the DIMODAN® RT concentration is 0.6%, the hardness level of the Moringa samples is broadly comparable. The hardness of the Lesquerella samples is significantly less for the concentration of 0.6%, but statistically similar for the 0.3%. The same general trends are seen for the stickiness results of FIG. 9.

Sensory tasting of the spreads, undertaken by an untrained panel resulted in the following comments for the high fat samples (1-6):

Sample 1 (DIMODAN® RT—0.3%) Soft and smooth with pleasant overall mouth feel.
Sample 2 (DIMODAN® RT—0.6%) Firmer than sample 1 and generally still soft and smooth. This resulted in a firmer mouth feel, but one that was still acceptable.
Sample 3 (Moringa—0.3%) Soft and smooth with a pleasant overall mouth feel
Sample 4 (Moringa—0.6%) Firmer than sample 3, softer than sample 2, and smooth to taste but firmer over all mouth feel than sample 3.
Sample 5 (Lesquerella—0.3%) Very soft, yellow in appearance, appeared unstable.
Sample 6 (Lesquerella—0.6%) Very soft, yellow in appearance, appeared unstable.

Here one can echo the conclusions drawn about the 60% fat spreads above that Moringa at 0.3 or 0.6% concentration can form acceptable stable spreads, where the level of firmness achieved can be controlled to the customer's taste and specifications by optimising the concentration.

### Summary/Discussion

In summary, the preset examples show that the functionality of Moringa monoglyceride in high fat spreads is such that it is capable of producing stable spread products that have a water droplet size capable of giving very good mouth feel qualities as well as good flavour release properties. It appears that fat based systems containing Moringa are able to survive processing and storage conditions to make commercially acceptable products.

The water binding properties of PGPR are one of the reasons that it is essentially the stabilising emulsifier of choice for many a fat-based system containing a water phase. However, the level of stability that the PGPR can confer is often such that any re-work of the system is made difficult, if not impossible, and this can result in production down time, or indeed loss of product yield. Therefore, if one could engineer an emulsifier that was able to maintain a stable, and robust emulsion like PGPR, and yet unlike PGPR; i.e. essentially a poorer PGPR, then one would have the potential to offer increased production time and perhaps improve production yield, allow re-work and importantly, to potentially enable removal of E476. The present emulsifier meets this requirement. We have shown that the functionality of Moringa is such that these stable spread products are able to be made, and that mouth feel and flavour release are more than acceptable. Similarly the water droplet size data teaches that while being stable, the products are not so ‘overly’ stable that potential re-work could not be carried out. Thus, it is believed that the advantage of using Moringa on its own would result in the formation of an emulsion that is stable, but not as tight as those usually seen when PGPR is used alone.

### Conclusion

The results presented here show that Moringa monoglycerides, when incorporated into a high fat spread (60%) are able to perform such that the resulting product is stable to processing and storage. The product has an acceptable commercial structure, and good flavour release. It is firm and spreadable without being too firm.

### 82% Fat Spread

High fat spread systems containing 60 wt. % triglycerides are discussed above The example below relates to the preparation of an 82 wt.% triglyceride retail margarine type system.

### Materials & Methods

The recipe for the two high fat (82%) retail style margarines is given in Table 16.

TABLE 16
Recipe for the two high fat (82%) retail style margarines,
sample 41 contains DIMODAN ® HP and sample
43 contains Moringa Monoglycerides (MM).

| Ingredient Name | 41 | 43 |
|---|---|---|
| Water (Tap) | 16.400 | 16.400 |
| Salt (Sodium Chloride) | 0.500 | 0.500 |
| Skimmed milk powder | 1.000 | 1.000 |
| Potassium Sorbate | 0.100 | 0.100 |
| Water phase total | 18.000 | 18.000 |
| pH | 5.5 | 5.5 |
| PK4 - INES | 25.000 | 25.000 |
| COLZAO | 75.000 | 75.000 |
| Fat blend total | 100.000 | 100.000 |
| DIMODAN ® HP Distilled Monoglyceride | 0.200 | |
| (KAB) Distilled Monoglyceride, | | 0.200 |
| Moringa Oil (Lot 2461-208) | | |
| 2% sol beta-carotene | 0.020 | 0.020 |
| Butter Flavouring 050001 T03007 | 0.030 | 0.030 |
| Other fat ingredients total | 0.250 | 0.250 |
| Fat phase total | 82.000 | 82.000 |
| RECIPE total (calc. batchsize) | 100.000 | 100.000 |

The procedure for making the margarines is given as follows;

### Water Phase:

1. Heat water to 80° C.
2. Mix dry ingredients
3. Slowly add dry ingredients to the water while stirring intensively. Stir for 4 minutes.
4. Cool water phase to 50° C.
5. Re-weigh and add water equivalent to the amount of evaporation
6. Adjust pH with citric acid or NaOH
7. Add flavour just before running the Perfector

### Fat Phase:

1. Weigh out emulsifier, beta carotene (2% solution) and oil/fat in the same container

### 2. Heat to 80° C.

3. Stir the fat phase until mixed well
4. Cool the fat phase to 50° C.
5. Add flavour just before running the Perfector

### Emulsion:

Add the water phase to the fat phase stirring intensively.

The conditions on the pilot plant are shown in Table 17.

TABLE 17
Pilot plant running conditions used for the production of the
two recipes given in Table 16. Here Samples 41 and 42 correspond
to sample 41, and Samples 43 and 44 correspond to sample 43.

| Pilot Plant | | | | |
|---|---|---|---|---|
| Processing (3-tube lab perfector): | 41 | 42 | 43 | 44 |
| Oil phase temperature | 50 | 50 | 50 | 50 |
| Water phase temperature | 50 | 50 | 50 | 50 |
| Emulsion temperature | 50 | 50 | 50 | 50 |
| Centrifugal pump | Auto | Auto | Auto | Auto |
| Capacity high pressure pump | 40 | 40 | 40 | 40 |
| Cooling (NH3) tube 1: | −10 | −10 | −10 | −10 |
| Cooling (NH3) tube 2: | −10 | −10 | −10 | −10 |
| Cooling (NH3) tube 3: | | | | |
| Rpm tube 1: | 1000 | 1000 | 1000 | 1000 |
| Rpm tube 2: | 1000 | 1000 | 1000 | 1000 |

The analysis run on the samples was water droplet size distribution, confocal laser scanning microscopy (CLSM), texture analysis and optical photography as described herein.

### Results & Discussion

The water droplet size distribution data for the two recipes shows very small sizes, the data is given in Table 18. The direct comparison between 60% fat spreads and 82% fat spreads shows that, as expected, in moving to higher fat contents the water droplet size decreases. The above reported water droplet sizes for 60% fat spreads were 25.55 microns and 13.14 microns for MM dosages of 0.3 and 0.6% respectively. In this case for 82% fat levels the MM dosage has decreased to 0.2% and the water droplet size has similarly decreased to 5.55 microns.

TABLE 18
Water droplet size distributions for the two high
fat (82%) retail margarines, sample 41 with DIMODAN ® HP,
and sample 43 with MM both dosages at 0.2%.

| | Average/ | | | |
|---|---|---|---|---|
| Sample ID | St. dev. | 2.5% < μm | 50% < μm | 97.5% < μm |
| DK18876-1(DK)-41 | Average | 1.56 | 2.58 | 4.23 |
| | St. dev. | 0.21 | 0.07 | 0.33 |
| DK18876-1(DK)-43 | Average | 1.15 | 2.53 | 5.55 |
| | St. dev. | 0.13 | 0.09 | 0.28 |

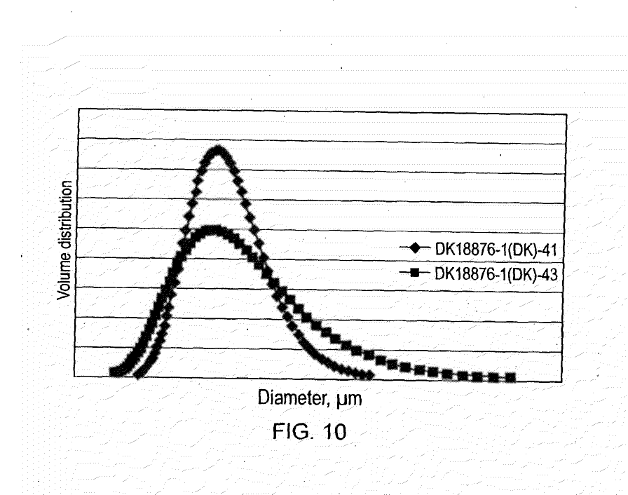

The water droplet size distribution is expressed in graphical form in FIG. 10.

In both cases the distribution is narrow, compared with those seen for lower fat contents.

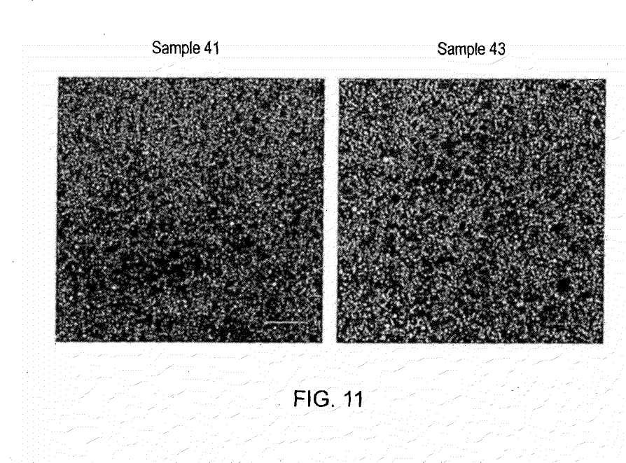

Examining the images from CLSM in FIG. 11 it can be seen that in each case the structure looks very similar. It can be seen that the general particle size is smaller on the left hand picture conforming to DIMODAN® HP than on the right hand picture for MM. This may result in an advantage—the water droplet size distribution for the MM is slightly broader, and the image from FIG. 2 shows a more open structure, which may be beneficial when it comes to baking properties, i.e. cake creaming.

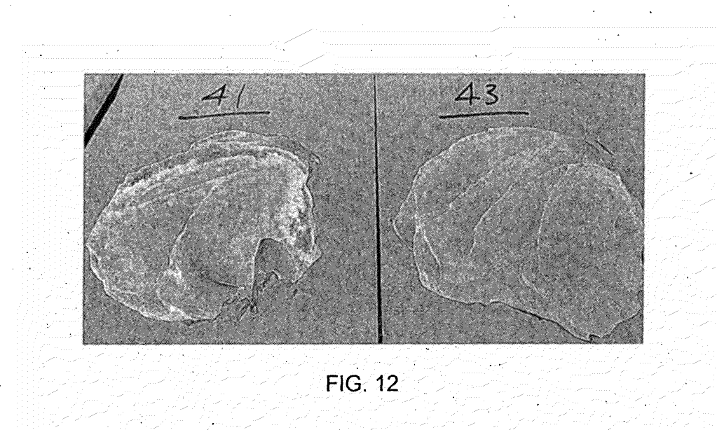

The results of the spreading test where the samples are worked onto cardboard are shown in FIG. 12.

Both samples were very stable, both in the pot and when worked onto the cardboard. Both produced a tight, compact, well formed emulsion which despite being firm was not hard. Both samples were eminently spreadable. There was no sign of oiling out, or release of what little water was present. Both could be worked well and hard with the knife without the samples suffering breakdown.

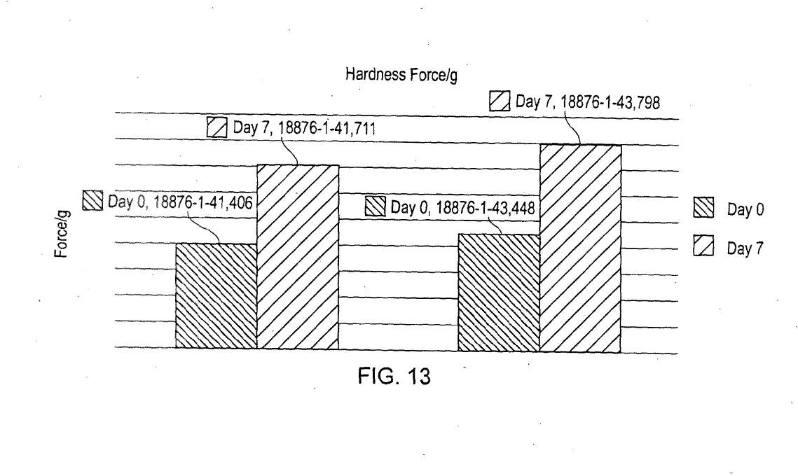

Regarding texture analysis giving the hardness of the samples, this data is given in FIG. 13.

The results of FIG. 13 essentially show that the two samples are similar although the precision of the measurements allows us to conclude that the sample containing MM is significantly firmer than that with DIMODAN® HP. We have seen from earlier data described above that the MM containing sample has the higher water droplet size, and from CLSM appears to have the more open structure. Both samples spread well during the spreading test, and with a higher, firmer result from texture analysis, perhaps this extra firmness could be used advantageously in the cake making process making the whipped cake mixture, pre-baking, more airy, fluffy.

### Conclusion

Incorporation of MM into high fat (82%) retail style margarine has been shown to be successful. Water droplet sizes are lower, as expected, than previously reported results from 60% fat systems, and are concurrent with the control sample at 85% fat levels. The MM containing sample gave slightly higher water droplet sizes, and a slightly broader size distribution. This was largely echoed in the CLSM images which showed the MM sample to be slightly more open in appearance compared to the DIMODAN® HP. In spreading, both samples held up well to the rigours of being spread back and forth; no sign of breakdown, oiling out, or water release was detected in either case. Texture analysis shows the MM sample having a significantly higher firmness compared to DIMODAN® HP and combined with apparent more open structure and broader water droplet size distribution attributes, this may prove advantageous in cake applications where the increased firmness and open structure may lend the cake dough a greater degree of air incorporation leading to a more airy, fluffy softer crumb on the cake. Cake tests would have to be carried out to verify this theory.

In summary, incorporation of MM into high fat margarine systems is extremely viable

### REFERENCES

Mullin, J. W. (1993) “Crystallisation” 3^{rd} Ed. Butterworth—Heinemann, UK. Pp 292-293.
Sakamoto, M., Maruo, K., Kuiryama, J., Kouno, M., Ueno, S, and Sato, K. (2003) “Effects of adding polyglycerol behenic acid esters on the crystallisation of palm oil” Journal of Oleo Science, 52, 639-645.
Wassell and Young (2007) “Food applications of trans fatty acid substitutes” International Journal of Food Science and Technology 42, 503-517.
Wassell, P. (2006) “Investigation into the Performance of Emulsified Liquid Shortening Containing Palm-Based Hard Stocks” Palm Oil Developments 45, 1-11.
Wassell, P. Bonwick, G., Smith, C. J., Almiron-Roig, E., and Young, N. W. G. (2010) Towards a Multidisciplinary Approach to Structuring in Reduced Saturated Fat-Based Systems—A Review” International Journal of Food Science and Technology 45 (4), 642-655.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A foodstuff in the form of a spread, wherein the spread is a water in oil emulsion containing
(a) a continuous fat phase; and
(b) a dispersed aqueous phase,
wherein the spread comprises
(i) triglycerides in an amount of from 41 to 90 wt. % based on the foodstuff; and
(ii) a mono or di ester of glycerol and Moringa oil.

2. A spread according to claim 1 containing (i) triglycerides in an amount of from 41 to 85 wt. % based on the foodstuff.

3. A spread according to claim 1 containing (i) triglycerides in an amount of from 41 to 80 wt. % based on the foodstuff.

4. A spread according to claim 1 containing (i) triglycerides in an amount of from 50 to 70 wt. % based on the foodstuff.

5. A spread according to claim 1 containing (i) triglycerides in an amount of from 55 to 65 wt. % based on the foodstuff.

6. A spread according to claim 1 wherein the spread is free of polyglycerol polyricinoleic acid.

7. A spread according to claim 2 wherein the spread is free of polyglycerol polyricinoleic acid.

8. A spread according to claim 3 wherein the spread is free of polyglycerol polyricinoleic acid.

9. A spread according to claim 4 wherein the spread is free of polyglycerol polyricinoleic acid.

10. A spread according to claim 5 wherein the spread is free of polyglycerol polyricinoleic acid.

11. A process for preparing a foodstuff in the form of a spread, wherein the spread comprises triglycerides in an amount of from 41 to 90 wt. % based on the foodstuff, comprising the steps of
(a) contacting
(i) a fat phase; and
(ii) an aqueous phase;
(b) forming an emulsion wherein the fat phase provides a continuous phase and wherein the aqueous phase provides a dispersed phase; and
(c) contacting the fat phase and the aqueous phase either before step (b) or after step
(b) with a mono or di ester of glycerol and Moringa oil.

12. The process according to claim 11 wherein the mono or di ester of glycerol and Moringa oil is present in the fat phase of step (a).

13. The process according to claim 11 containing (i) triglycerides in an amount of from 41 to 85 wt. % based on the foodstuff.

14. The process according to claim 12 containing (i) triglycerides in an amount of from 41 to 85 wt. % based on the foodstuff.

15. The process according to claim 11 containing (i) triglycerides in an amount of from 41 to 80 wt. % based on the foodstuff.

16. The process according to claim 12 containing (i) triglycerides in an amount of from 41 to 80 wt. % based on the foodstuff.

17. The process according to claim 11 containing (i) triglycerides in an amount of from 50 to 70 wt. % based on the foodstuff.

18. The process according to claim 12 containing (i) triglycerides in an amount of from 50 to 70 wt. % based on the foodstuff.

19. The process according to claim 11 containing (i) triglycerides in an amount of from 55 to 65 wt. % based on the foodstuff.

20. The process according to claim 12 containing (i) triglycerides in an amount of from 55 to 65 wt. % based on the foodstuff.

21. The process according to claim 11 wherein the spread is free of polyglycerol polyricinoleic acid.

22. The process according to claim 12 wherein the spread is free of polyglycerol polyricinoleic acid.

23. A process for preparing or stabilizing a spread using a mono or di ester of glycerol and Moringa oil, wherein the spread is a water in oil emulsion containing
(a) a continuous fat phase; and
(b) a dispersed aqueous phase,
wherein the spread comprises (i) triglycerides in an amount of from 41 to 90 wt % based on the foodstuff.

24. The process of claim 23 wherein the spread comprises (i) triglycerides in an amount of from 41 to 85 wt. % based on the foodstuff.

25. The process of claim 23 wherein the spread comprises (i) triglycerides in an amount of from 41% 80 wt. % based on the foodstuff.
